(19) United States
(12) Patent Application Publication
(10) Pub. No.: US 2010/0133414 A1
(43) Pub. Date: Jun. 3, 2010

(54) MOBILE TERMINAL HAVING SUPPORTING MEMBER

(75) Inventors: Kee Moon LEE, Seoul (KR); Hyun Seop Kim, Seoul (KR); Chang Hwan Hwang, Seongnam-si (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/628,653

(22) Filed: Dec. 1, 2009

(30) Foreign Application Priority Data
Dec. 1, 2008 (KR) 10-2008-0120676

(51) Int. Cl. F16M 13/00

(52) U.S. Cl. 248/686; 248/688

(57) ABSTRACT

A mobile terminal having a supporting member is provided. The mobile terminal includes a main body having a first hinge portion, a first part mounted in the main body, and the supporting member having a second hinge portion connected to the first hinge portion. The supporting member is inserted into the main body and coupled to the main body by rotating about the first hinge portion. By integrally forming the main body of the mobile terminal and the supporting member, a manufacturing cost of the mobile terminal can be reduced and inadvertent loss of the supporting member by a user can be prevented. Further, when the supporting member is stored in a folded position in the main body of the mobile terminal, the supporting member can be used for aesthetic purposes and can provide an enhanced external appearance.

### CROSS REFERENCE TO RELATED APPLICATION

This application claims priority from and the benefit of Korean Patent Application No. 10-2008-0120676, filed on Dec. 1, 2008, which is hereby incorporated by reference for all purposes as if fully set forth herein.

### BACKGROUND OF THE INVENTION

1. Field of the Invention

Exemplary embodiments of the present invention relate to a mobile terminal, and more particularly, to a mobile terminal having a supporting member formed integrally with a main body of the mobile terminal.

2. Description of the Background

As multimedia applications and digital multimedia broadcasting (DMB) content is are increasingly used and displayed in mobile terminals, there is a growing demand for improving viewing experiences of display screens in mobile terminals.

Carrying an unattached or separate supporting member may be very inconvenient for users, and the supporting member may easily be lost or misplaced. Accordingly, there is a need for an extendable supporting member to be mounted in a mobile terminal. However, if a supporting member is simply added as an external feature to the mobile terminal, the overall size of the mobile terminal increases, and an external appearance of the mobile terminal, which may already be disfigured by the presence of visible functional features, such as a camera unit and/or an interface terminal, attached to the mobile terminal, may further be disfigured.

Because an enhanced external appearance of a mobile terminal has a great influence on its marketability and price, the external appearance of the mobile terminal is very important.

As further functions are added to a mobile terminal, the size of the mobile terminal may increase. However consumers typically prefer a smaller size and simpler structure for mobile terminals. Further, in order to conveniently view a multimedia function, such as DMB broadcasting and/or a moving picture reproduction, a supporting member should preferably be added to the mobile terminal. However it is difficult to store such a supporting member in the mobile terminal while retaining its small size and without disfiguring the external appearance of the mobile terminal.

### SUMMARY OF THE INVENTION

Exemplary embodiments of the present invention provide a mobile terminal having a supporting member formed integrally with a main body of the mobile terminal.

Additional features of the invention will be set forth in the description which follows, and in part will be apparent from the description, or may be learned by practice of the invention.

Exemplary embodiments of the present invention disclose a mobile terminal having a supporting member. The mobile terminal includes a main body, a first part, and a supporting member. The main body comprises a first hinge portion. The first part is supported by the main body. The supporting member has a second hinge portion and is connected to the first hinge portion. The supporting member is connected to the main body about the first hinge portion. The supporting member is configured to extend outward from the main body by being rotated about the first hinge portion.

Exemplary embodiments of the present invention disclose a device including a main body and a supporting member. The main body includes a locking device and a first hinge portion. The supporting member includes a second hinge portion. The supporting member is configured to rotate about the first hinge portion. The second hinge portion is coupled to the first hinge portion. The locking device and first hinge portion lock the supporting member in a plurality of rotation positions of the supporting member.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, is illustrate exemplary embodiments of the invention, and together with the description serve to explain the principles of the invention.

FIG. 1 is a perspective view illustrating a structure of a mobile terminal having a supporting member according to exemplary embodiments of the present invention.

FIG. 2 is a perspective view illustrating the supporting member in an extended position according to exemplary embodiments of the present invention.

FIG. 3 is an enlarged perspective view illustrating the supporting member folded within the mobile terminal of FIG. 1 according to exemplary embodiments of the present invention.

FIG. 4 is a cross-sectional perspective view illustrating a locking structure of the supporting member folded within the mobile terminal of FIG. 1 according to exemplary embodiments of the present invention.

FIG. 5 is a cross-sectional perspective view illustrating a shape of the locking structure while the supporting member is rotating, according to exemplary embodiments of the present invention.

FIG. 6 is a cross-sectional perspective view illustrating a shape of the locking structure when the supporting member is extended, according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as is limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

Hereinafter, exemplary embodiments of the present invention are described in detail with reference to the accompanying drawings.

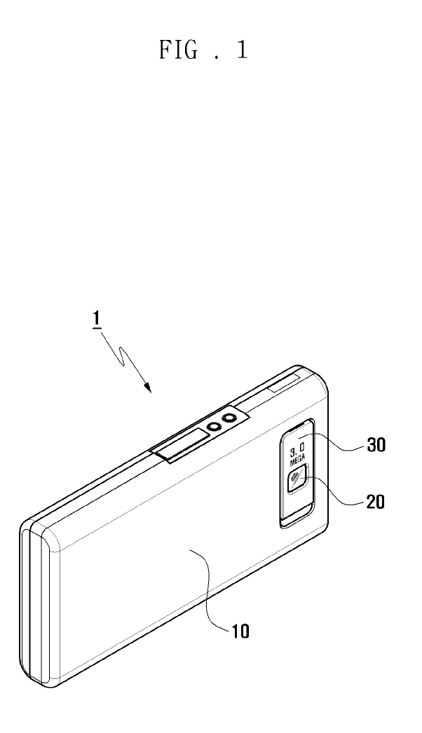

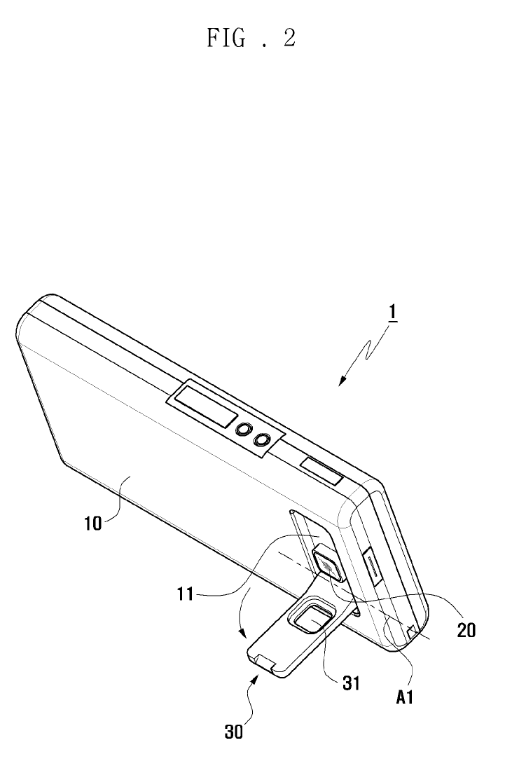

FIG. 1 is a perspective view illustrating a structure of a mobile terminal having a supporting member according to exemplary embodiments of the present invention. FIG. 2 is a perspective view illustrating the supporting member in an extended position.

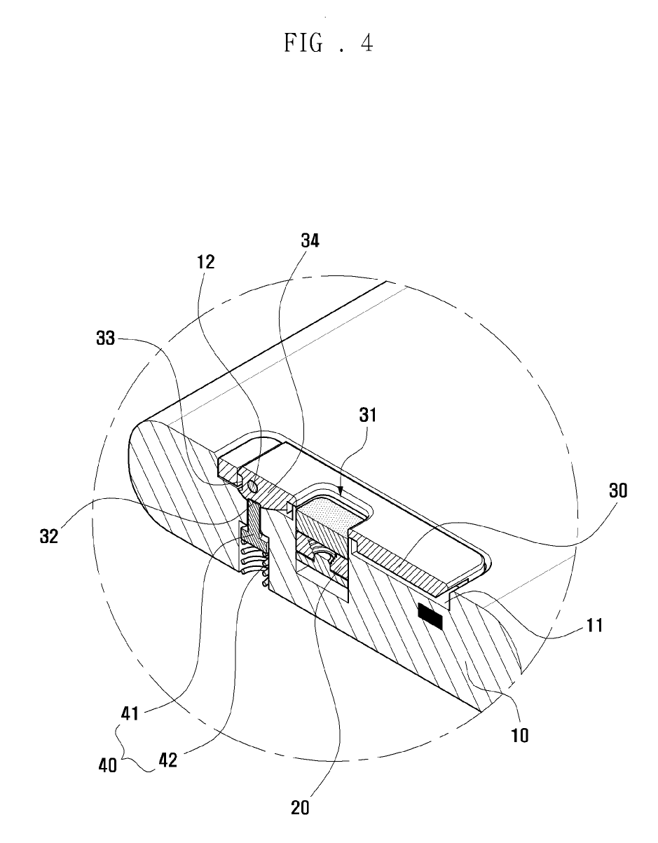

A mobile terminal 1 having a supporting member may include a main body 10, an externally visible first part 20 (e.g., camera unit) mounted in the main body 10, and a supporting member 30. A first hinge portion 12 (shown in FIG. 4) of the main body 10 may be connected to a second hinge portion 34 (shown in FIG. 4) formed at one end of the supporting member 30. The supporting member 30 may be inserted into and coupled to the main body 10, and may extend outwards from the main body 10 by rotating the supporting member 30 about the first hinge portion 12.

In some cases, the externally visible first part 20 may be exemplified as a camera unit, however the first part 20 may not be limited thereto and may be one of various parts, such as, for example, an interface terminal and/or a key button.

Referring to FIG. 1, the supporting member 30 may be mounted in the main body 10 of the mobile terminal 1, and the first part 20 mounted in the mobile terminal 1 may be exposed through an opening 31 (see FIG. 2) of the supporting member 30.

Referring to FIG. 2, the supporting member 30 may be extended by rotating the is supporting member 30 about a rotation axis A1 of the first hinge portion 12 formed in the main body 10 of the mobile terminal 1. A recess portion 11 for inserting the supporting member 30 may then exist in the main body 10 of the mobile terminal 1.

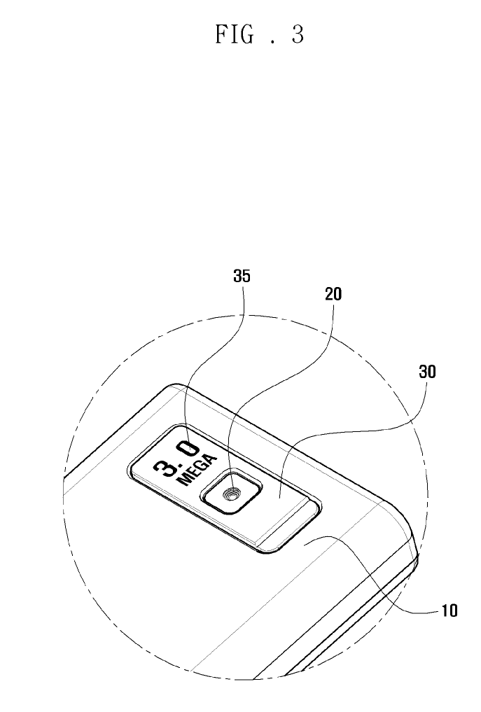

FIG. 3 is an enlarged perspective view illustrating the supporting member 30 folded within the mobile terminal 1 of FIG. 1.

In the folded state, the supporting member 30 may include a marking portion 35 for decorating an external appearance of the camera unit 20. The marking portion 35 may be exposed to the outside of the supporting member 30 and can be used to display information associated with the camera unit 20. In FIG. 3, the marking portion 35 of the mobile terminal 1 may display “3.0 MEGA,” which is a pixel specification of the camera unit used as the first part 20. Further, the outer surface of the supporting member 30 disposed within the recess portion 11 may be located at the same level as the outer surface of the mobile terminal 1. When the supporting member 30 is folded into the main body 10 of the mobile terminal 1, the supporting member 30 can perform a function to provide an enhanced external appearance of the camera unit. Further, the camera unit may be designed such that only a lens portion thereof is exposed through the opening 31 of the supporting member 30, and thereby, the camera unit 20 can be protected from a surrounding impact.

The mobile terminal 1 having the supporting member 30 may include a locking device 40 (see FIG. 4) for controlling a rotation of the supporting member 30. The locking device 40 may hold the supporting member 30 at a specific position when the supporting member 30 rotates.

FIG. 4 is a cross-sectional perspective view illustrating a locking structure of the supporting member 30 folded within the mobile terminal 1 of FIG. 1.

Referring to FIG. 4, the supporting member 30 may include a first recess 32 and a second recess 33 formed in the second hinge portion 34 in a direction of rotation about the first hinge portion 12. The first recess 32 and the second recess 33 may each retain the supporting member 30 at one or more specific rotational positions of the supporting member 30. For example, the first recess 32 may retain the supporting member 30 in a folded position. The second recess 33 may retain the supporting member 30 in a completely extended position. The supporting member 30 can thereby be retained in any folded and extended position by providing the first recess 32 and the second recess 33.

The locking device 40 may include a pressing projection 41 that is inserted into one of the first recess 32 and the second recess 33 when the supporting member 30 rotates, and an elastic body 42 for providing an elastic pushing force to the pressing projection 41. The pressing projection 41 may be provided in the main body 10 of the mobile terminal 1 adjacent to the first hinge portion 12, and the elastic body 42 may be connected to the outer end of the pressing projection 41. The elastic body 42 may be a compression spring, however the elastic body 42 is not limited thereto. As the supporting member 30 rotates or extends, the pressing projection 41 may engage with one of the first recess 32 and the second recess 33 to retain the supporting member 30 in a predetermined position.

FIG. 4 illustrates a state in which the supporting member 30 is folded and the pressing projection 41 is inserted into the first recess 32.

The first hinge portion 12 formed in the main body 10 may be embodied as a shaft. The second hinge portion 34 formed in the supporting member 30 may include a penetrating hole for inserting the shaft of the first hinge portion 12. The rotation axis A1 may be formed along a central axis of the shaft. The supporting member 30 may rotate about the shaft. The structure of the second hinge portion 34 and the first hinge portion 12 is not limited to that shown in FIG. 4 and various structures and arrangements of the second hinge portion 34 and the first hinge portion 12 can be used.

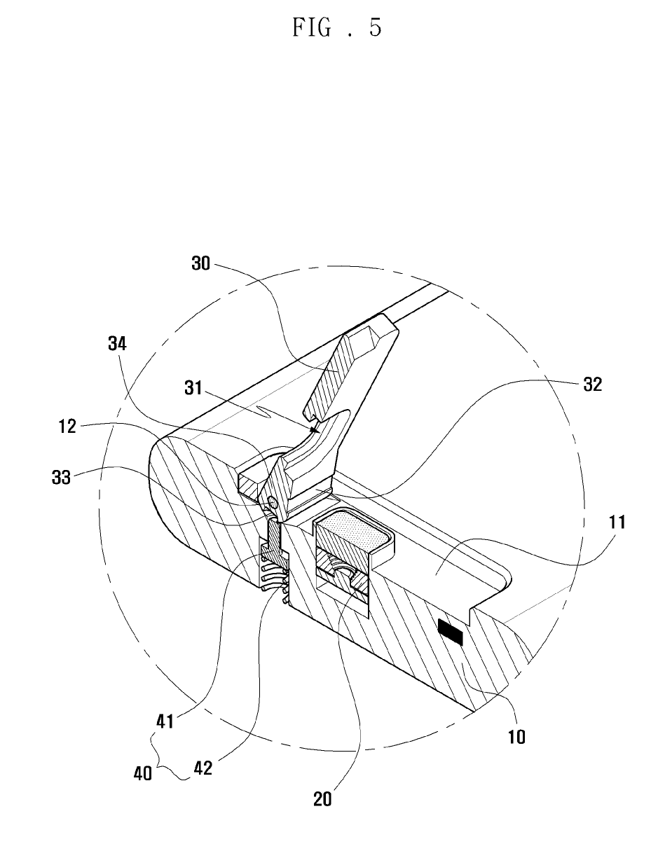

FIG. 5 is a cross-sectional perspective view illustrating a shape of the locking structure while the supporting member 30 is rotating.

Referring to FIG. 5, when the supporting member 30 rotates from the folded state to an extended state, the pressing projection 41 may escape from the first recess 32. In this case, the pressing projection 41 may be pressed towards the elastic body 42 by the supporting member 30 and the elastic body 42 may be compressed.

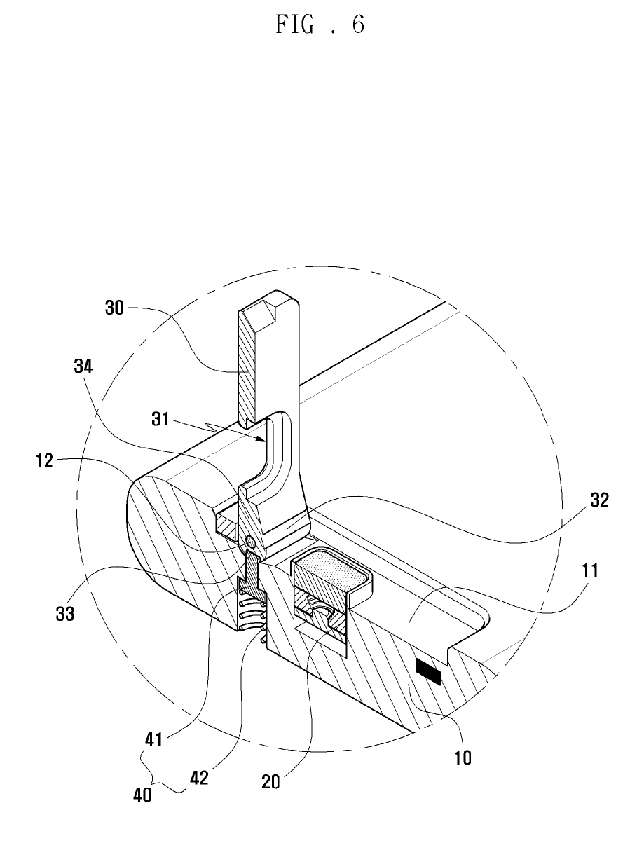

FIG. 6 is a cross-sectional perspective view illustrating a shape of the locking structure when the supporting member 30 is extended.

FIG. 6 illustrates the supporting member 30 completely extended for supporting the mobile terminal 1. When the supporting member 30 is completely extended, the pressing projection 41 may be pressed against the elastic body 42 by the supporting member 30 and the pressing projection 41 may engage with the second recess 33. The elastic body 42 may provide a force for retaining the supporting member 30 in the completely extended position by pushing the pressing projection 41 in a direction towards the second recess 33. The retained supporting member 30 can thus be used to support the mobile terminal 1 at a predetermined angle with respect to the main body of the mobile terminal 1.

Further, by setting the locations of the first recess 32 and the second recess 33 formed in the supporting member 30, predetermined rotation angles of the supporting member 30 can be set.

The mobile terminal according to exemplary embodiments of the present is invention may be any information, communication, or multimedia device, such as, for example, a mobile communication terminal, mobile phone, personal digital assistant (PDA), smart phone, International Mobile Telecommunication 2000 (IMT-2000) terminal, code division multiple access (CDMA) terminal, wideband code division multiple access (WCDMA) terminal, Global System for Mobile Communication (GSM) terminal, general packet radio service (GPRS) terminal, enhanced data GSM environment (EDGE) terminal, universal mobile telecommunication service (UMTS) terminal, and digital broadcasting terminal.

Further, exemplary embodiments of the present invention can be applied to various configuration types of mobile terminals, such as, for example, a bar type, flip type, folder type, sliding type, rotating type, and/or any combination of configuration types.

As described above, by integrally forming a main body of a mobile terminal and a supporting member, a manufacturing cost of the mobile terminal can be reduced and an inadvertent loss of the supporting member by a user can be prevented. Further, when the supporting member is stored in a folded position in the main body of the mobile terminal, the supporting member can be used for aesthetic purposes, thereby providing an enhanced external appearance.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A mobile terminal having a supporting member, the mobile terminal comprising:
a main body comprising a first hinge portion;
a first part supported by the main body; and
a supporting member comprising a second hinge portion and connected to the first hinge portion,
wherein the supporting member is connected to the main body about the first hinge portion, and the supporting member is configured to extend outward from the main body by being rotated about the first hinge portion for performing a function of supporting the main body when the mobile terminal is located on a surface.

2. The mobile terminal of claim 1, wherein the first part comprises a camera unit.

3. The mobile terminal of claim 1, wherein the first part comprises an interface terminal.

4. The mobile terminal of claim 1, wherein the supporting member comprises an opening for exposing a portion of the first part.

5. The mobile terminal of claim 1, wherein the supporting member comprises a marking portion on an exposed surface of the supporting member to display information associated with the first part.

6. The mobile terminal of claim 1, wherein the first part comprises a mounting portion situated at a recess portion of the main body, the supporting member being inserted in the recess portion.

7. The mobile terminal of claim 1, further comprising a locking device to control rotation of the supporting member, wherein the supporting member is retained at least one of a first rotational position and a second rotational position of the supporting member.

8. The mobile terminal of claim 7, wherein the supporting member comprises a first recess and a second recess formed in the second hinge portion, the first recess and the second recess corresponding to the first rotational position and the second rotational position, respectively, and
wherein the locking device comprises:
a pressing projection inserted into one of the first recess and the second recess in response to rotation of the supporting member; and
an elastic body to provide an elastic pushing force to the pressing projection.

9. A device, comprising:
a main body comprising a locking device and a first hinge portion; and
a supporting member comprising a second hinge portion, the supporting member configured to rotate about the first hinge portion,
wherein the second hinge portion is coupled to the first hinge portion, and
wherein the locking device and second hinge portion lock the supporting member in a plurality of rotation positions of the supporting member.

10. The device of claim 9, further comprising a first part integrated in the main body, and wherein the supporting member is mounted in the main body.

11. The device of claim 9, wherein the locking device comprises a pressing projection and a elastic body, the elastic body comprising a spring, and
wherein the supporting member further comprises a first recess and a second recess formed in the second hinge portion.

12. The device of claim 11, wherein the first recess locks the supporting member in a first rotation position and the second recess locks the supporting member in a second rotation position.

13. The device of claim 12, wherein the first rotation position comprises the supporting member being folded and an outer surface of the supporting member being coplanar with an outer surface of the main body, and the second rotation position comprises the supporting member being extended outwardly away from the outer surface of the main body.

14. The device of claim 11, wherein the pressing projection is inserted in the first recess or the second recess in response to rotation of the supporting member,
wherein the elastic body supports insertion of the pressing projection, and
wherein a shaft of the first hinge portion is inserted in an opening in the second hinge portion, a rotation axis of the rotation of the supporting member being along the shaft.

15. The device of claim 10, wherein the supporting member comprises an opening for exposing at least a portion of the first part, the first part comprising an image capturing device.
